(19) United States
(12) Patent Application Publication
(10) Pub. No.: US 2026/0342660 A1
(43) Pub. Date: Oct. 29, 2026

(54) INTER-PLANE SERVICE BASED ARCHITECTURE IN A WIRELESS COMMUNICATIONS NETWORK

(71) Applicant: LENOVO (SINGAPORE) PTE. LTD., Singapore (SG)

(72) Inventors: Emmanouil PATEROMICHELAKIS, Viersen (DE); Konstantinos SAMDANIS, Munich (DE)

(21) Appl. No.: 19/111,537

(22) PCT Filed: Nov. 18, 2022
(86) PCT No.: PCT/EP2022/082425

§ 371 Date: Mar. 13, 2025

(30) Foreign Application Priority Data
Sep. 30, 2022 (GR) 20220100804

(51) Int. Cl. H04L 41/0895; H04L 41/122; H04L 41/5051

(52) U.S. Cl. CPC H04L 41/0895; H04L 41/122; H04L 41/5051

(57) ABSTRACT

There is provided a method in a configuration entity, the configuration entity in a wireless communication network. The method comprises receiving a request for inter-plane service-based architecture management from a consumer. The method further comprises generating a configuration for a microservice environment based on the request, wherein the microservice environment comprises a plurality of microservices and a topology of the service based architecture. The method further comprises controlling at least one capability and/or permission related to the microservices within the microservice environment based on the configuration.

### FIELD

The subject matter disclosed herein relates generally to the field of implementing inter-plane service based architectures in a wireless communication network. This document defines methods in a configuration entity and a microservice provider entity in a wireless communication network. This document further defines a configuration entity and a microservice provider entity, in a wireless communication network.

### BACKGROUND

Service based architectures have evolved from monolithic to service-oriented architecture (SOA) and then towards microservices and serverless systems. A SOA is a software architecture style that refers to an application composed of discrete and loosely coupled software agents that perform a required function. SOA has two main roles: a service provider and a service consumer. Both roles can be played by a software agent. The concept of SOA lies in the following: an application can be designed and built in a way that its modules are integrated seamlessly and can be easily reused.

Microservice is a type of service-oriented software architecture that focuses on building a series of autonomous components that make up an application. Unlike monolithic applications built as a single indivisible unit, microservice applications consist of multiple independent components that are glued together with Application Programming Interfaces (APIs). The biggest advantage of microservices over other architectures is that small single services can be built, tested, and deployed independently. On the contrary, the disadvantages of microservices based architecture, are that each functionality that communicates externally via an API increases the chance of attacks. These attacks can happen only if proper security measurements aren't implemented when building an application. Also, using different languages makes deployment more difficult.

Serverless architecture is a cloud computing approach to building and running applications and services without the need for infrastructure management. In serverless applications, code execution is managed by a server, allowing developers to deploy code without worrying about server maintenance and provision. In fact, serverless doesn't mean “no server.” The application is still running on servers, but a third-party cloud service takes full responsibility for these servers. A serverless architecture eliminates the need for extra resources, application scaling, server maintenance, and database and storage systems.

In microservices architecture, applications and services often require related functionality, such as monitoring, logging, configuration, and networking services. These peripheral tasks can be implemented as separate components or services. If the application is decomposed into services, then each service can be built using different languages and technologies. While this gives more flexibility, it means that each component has its own dependencies and requires language-specific libraries to access the underlying platform and any resources shared with the parent application. In addition, deploying these features as separate services can add latency to the application. The sidecar pattern is a single-node pattern made up of two containers. The first is the application container. It contains the core logic for the application. Without this container, the application would not exist. In addition to the application container, there is a sidecar container.

The role of the sidecar is to augment and improve the application container, often without the application container's knowledge. In its simplest form, a sidecar container can be used to add functionality to a container that might otherwise be difficult to improve. A key benefit of sidecars is that it allows primary application to use a heterogeneous set of languages and frameworks. A component located in a sidecar service can be consumed by applications written in different languages using different frameworks.

Vertical Application Enablement is one of the key topics in 5G standardization, for providing a framework to ease the integration with vertical applications. Middleware/“Enabler” layer is investigated as a common services platform to ease the vertical integration with 5GS, to provide support capabilities to assist verticals (automotive, smart factory, drones, mIOT) when interacting with one or more 4G/5G networks (PLMNs, NPNs); and to allow the dynamic translation of the vertical application requirements to network requirements and vice versa.

Different middleware implementations based on scenario (vertical-specific, common services for all verticals, targeting MEC deployments) can be possible and also the enablement layer entities (SEAL, EDGAPP, vertical-specific enablers, CAPIF, . . . ) can be deployed either by the MNO (as NetApps) or by the edge/cloud provider (e.g. AWS) or the vertical customer (e.g. factory owner, stadium event organizer). In fact there are different business/ownership models for the enabler layer: Model 1 (e.g. smart city scenario): Edge Enabler owned by MNO, App enabler by ECSP, end user app (by application vendor); Model 2 (e.g. smart factory): app/edge enablers owned by operator or trusted ECSPs; Model 3 (e.g. video streaming SPs): edge enabler owned by MNO, app enabler/end app by app vendors; Model 4: app/edge enabler and apps are owned by one entity (e.g. MNO for port-management service, or global gaming vendor).

### SUMMARY

3GPP including the enablement layer (as specified in SA6) uses service-based representations of the architecture (SBA). However, different architectures have different types of SBA: 3GPP SA2 which is about the 3gpp system architecture uses conventional SBA, where the NF is the service producer and the SBI bus is used for the interaction with service consumers (NFs/AFs); 3GPP SA5, which is about OAM aspects of the network, uses service-based management architecture, closer to microservice paradigm; 3GPP SA5 specifies the notion of MnS as an API that can be integrated in any management function—allows an MnS Producer to interact with an MnS Consumer (a service producer with a service consumer) via a standardized MnS interface; and 3GPP SA6 uses SA2 paradigm for SEAL, however in other enablers (like EDGEAPP) the service-based support has different variants (SA2-based for interaction with 5GC, and microservice-based for interaction among EDGEAPP entities incl. EEC).

The notion of a service can be better defined in the context of microservices and in the context of 3GPP SA2 and 3GPP SA5. In 3GPP SA2, the notion of service is related to NF capabilities/services. Such services are discovered using NRF at a functional level. Example of services are the AMF services, NEF services etc. The SBA architecture is specified in 3GPP TS 23.502. In 3GPP SA5, Service Based Management Architecture (SBMA) is defined and comprises Management Services (MnS). A MnS is a set of offered capabilities for management and orchestration of network and services. The entity producing an MnS is called MnS producer. The entity consuming an MnS is called MnS consumer. An MnS provided by an MnS producer can be consumed by any entity with appropriate authorization and authentication. An MnS producer offers its services via a standardized service interface composed of individually specified MnS components.

In 3GPP there can be different interactions among different planes/domains (OAM, 5GS, application enablement), since the enablement layer is on top of 5G core and OAM, and there are interactions via APIs which can be service based. Such interactions may involve different MNOs, ECSPs, CSPs, verticals, ASPs/enterprises. If we want to have inter-plane SBA for some cases including multiple service providers, then there needs to be a secure, flexible, and consumer-friendly architecture. For this reason, the use of service mesh may be beneficial for such cross-domain interactions.

The high-level problem to be solved by this disclosure is how to configure and optimize a microservice environment within a wireless communications system comprising of multiple domains for service mesh deployments (e.g. using sidecars).

Disclosed herein are procedures for inter-plane service-based architectures in a wireless communication network. Said procedures may be implemented by a method in a configuration entity in a wireless communication network and/or a method in a microservice provider entity in a wireless communication network. Furthermore said procedures may be implemented by a configuration entity and/or a microservice provider entity, in a wireless communication network.

There is provided a method in a configuration entity, the configuration entity in a wireless communication network, comprising: receiving a request for inter-plane service-based architecture management from a consumer; generating a configuration for a microservice environment based on the request, wherein the microservice environment comprises a plurality of microservices, and a topology of the service based architecture; and controlling at least one capability and/or permission related to the microservices within the microservice environment based on the configuration.

There is further provided a configuration entity in a wireless communication network, comprising: a transceiver arranged to receive a request for inter-plane service-based architecture management from a consumer; and a processor arranged to generate a configuration for a microservice environment based on the request, wherein the microservice environment comprises a plurality microservices, and a topology of the service based architecture; wherein the processor is further arranged to control at least one capability and/or permission related to the microservices within the microservice environment based on the configuration.

There is further provided a microservice provider entity in a wireless communication network, comprising a transceiver arranged to receive a configuration for a microservice of a microservice environment, the microservice being registered with a respective registry, wherein the microservice environment comprises a plurality of microservices and a topology of the service based-architecture; and a processor arranged to configure a microservice based on the configuration.

There is also provided a method in a microservice provider entity, the microservice provider entity in a wireless communication network, comprising receiving a configuration for a microservice of a microservice environment, the microservice being registered with a respective registry, wherein the microservice environment comprises a plurality of microservices and a topology of the service based architecture; and configuring a microservice based on the configuration.

A configuration entity may interchangeably be referred herein to as a microservice configuration entity, an inter-plane microservice configurator. A microservice provider entity may also be referred to as an inter-plane microservice configuration/configurator client.

Inter-plane is defined as inter-domain or cross-domain or cross-platform. In this context, “plane” or “domain” or “platform” can have equivalent definitions, and in this invention, these can be for example: a core network; an edge data network; a cloud/centralized data network; a management system; an application at the UE/device side; an edge/MEC system; a RIC platform; an application enablement domain/platform; an edge enablement domain/platform.

The microservice environment configuration may comprise the configuration related to at least one of microservices, containers, service mesh, service discovery, and API gateways.

The main component of microservices architecture is the self-contained services. They can be any language and function separate from one another, making them ideal for implementation through various software teams.

The containers are a package of software that functions independently. Containers work to isolate each service in the same environment. In order to create microservices, a virtual machine can serve as a container and simulate the functionaries of a standard physical computer. Containers provide efficiency because they only rely on specific dependencies and the underlying code within the service. Containers also provide resource-efficient means to package services and give developers various deployment alternatives. Additionally, container orchestration tools like Kubernetes provide automating scalability and container management.

The service mesh offers a layer of infrastructure that provides additional security and makes for more predictable behaviors in terms of communication. The service mesh may also use a sidecar pattern and utilizes sidecar proxies to provide dynamic messaging. This setup allows the developer to forego having to use code when creating portions of the application.

The service discovery helps managing deployment and evenly distributing the load. This component features a service consumer, service provider, and service registry. The services mesh uses a service provider, a service registry, and a service consumer to distribute loads and adapt to changes in the deployment.

The API gateway is an essential part of communication in the complex distributed microservices architecture. It can handle administrative tasks, ensure the microservices load is lightweight, and perform load balancing actions when necessary. The API gateway also allows for faster communications between clients and microservices. This setup differs from SOA, or service-oriented architecture.

Whilst the microservice environment comprises the plurality of microservices and topology, it is not limited thereto. Indeed, the microservice environment may also comprise optionally the service mesh, service discovery, and API gateway.

A consumer can be one or more of: a VAL server, a VAL client, an edge server, an application or edge enabler client at the device, an application server, an application client, a network function, a management or OAM entity, a consumer of a telco service, a network operator, a SEAL server, a MEC application, a MEC service, a RIC service.

A permission may refer in certain embodiments to the allowable actions of a microservice or sidecar/proxy/gateway within the microservice environment, including read, write, delete, expose, re-expose, abstract or aggregate actions.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for inter-plane service based architectures in a wireless communication network will now be described, by way of example only, with reference to the accompanying drawings, in which:

FIG. 1 illustrates an embodiment of a wireless communication network;

FIG. 2 illustrates an embodiment of a user equipment apparatus;

FIG. 3 illustrates an embodiment of a network node;

FIG. 4 illustrates the evolution of service orientated architectures;

FIG. 5 illustrates an embodiment of a high-level inter-plane microservice architecture;

FIG. 6 illustrates different embodiments of service mesh deployments;

FIG. 7 illustrates an embodiment of a sidecar deployment;

FIG. 8 illustrates an embodiment of a method in a configuration entity;

FIG. 9 illustrates a further embodiment of a method using a configuration entity;

FIG. 10 illustrates an embodiment of a microservice deployment; and

FIG. 11 illustrates a further embodiment of a method using a configuration entity and a microservice provider entity.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

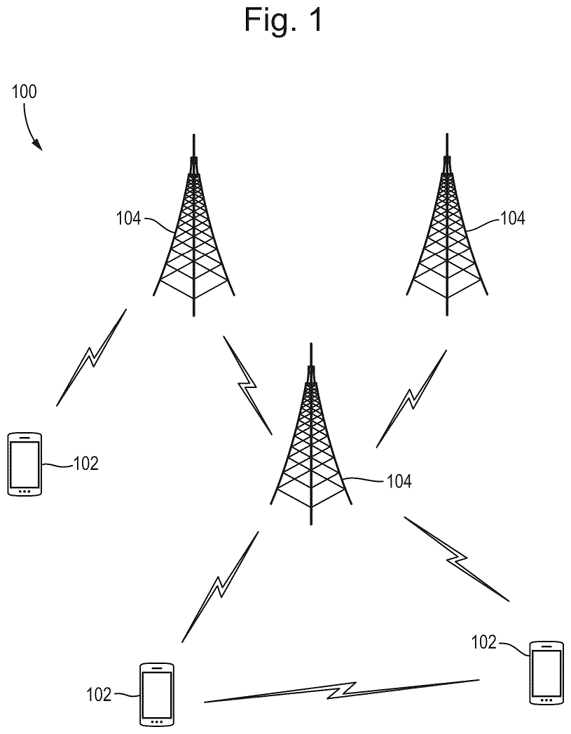

FIG. 1 depicts an embodiment of a wireless communication system 100 for inter-plane service-based architectures. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In 3GPP SA6, an application support layer has been specified for vertical applications, known as vertical application enabler layer (V2X enabler server at TS 23.286, FF enabler server at TR 23.745, UAS enable server at TS 23.255) which acts as a middleware for exposing northbound APIs to verticals as well as to provide some server-client support functionalities for the connected devices. Also, 3GPP SA6 has provided a common for all verticals enabler layer known as SEAL (TS 23.434).

SEAL (TS 23.434) has introduced a new service, namely Network Slice Capability Enablement (NSCE) layer, which has a server and client application counterpart. NSCE layer provides a network slice adaptation/migration capability for all devices running an application. This requires interaction between the OAM and NSCE server as well as the NSCE server and the NSCE client at the device side (for applying the slice adaptation). Further a new SEAL service is being defined related to Application Data Analytic Enablement service (ADAES, see TR 23.700-36) which supports the enablement of data analytics from 5G side as well as from 3rd party and provides a standardized way of analytics exposure.

Also, 3GPP SA6 is specifying a Common API Framework (CAPIF) was developed to enable a unified Northbound API framework across 3GPP network functions, and to ensure that there is a single and harmonized approach for API development [TS 23.222]. Some key functionalities in CAPIF are: CAPIF Core Function (CCF) is a repository of all, PLMN and 3rd party, service APIs; API Exposing Function (AEF) is the provider of the services as APIs; API Invoker is typically the applications that require service from the service providers.

The configuration and translation of platform dependent APIs to platform agnostic APIs, and SDK provided by edge/cloud platforms, whilst considering a problem having the same roots, does not configure sidecar/proxies, and instead just enable the translation of APIs. Sidecars are used mainly for microservices/SBA in service meshes, and the capability of the prior art is a middleware capability/API gateway (of a different technology) which configures and translates service APIs to slice/telco agnostic APIs.

Similarly, configuring a microservice environment and policies and based on this migrating services to microservice environment is different to that proposed herein, where a mapping of different types of telco services to a microservice environment is performed with configuration of proxies/sidecars to allow inter-plane SBA.

This solution proposed herein is a system and a method for configuring telco provided services as microservices. In particular, the configuration comprises the determination of parameters by proxies/sidecars/gateways when the interaction between microservices is inter-plane/cross domain.

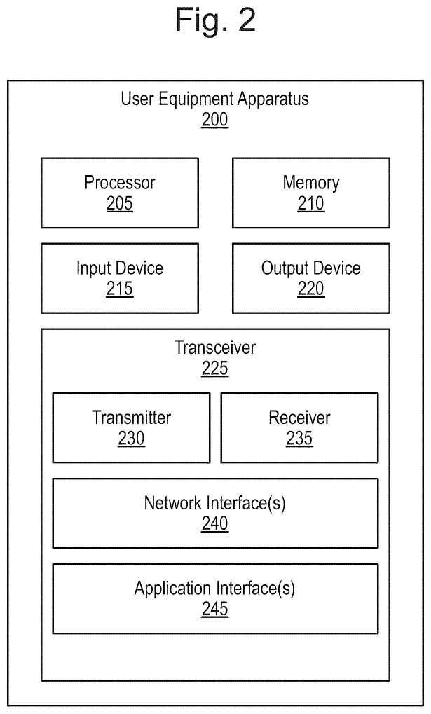

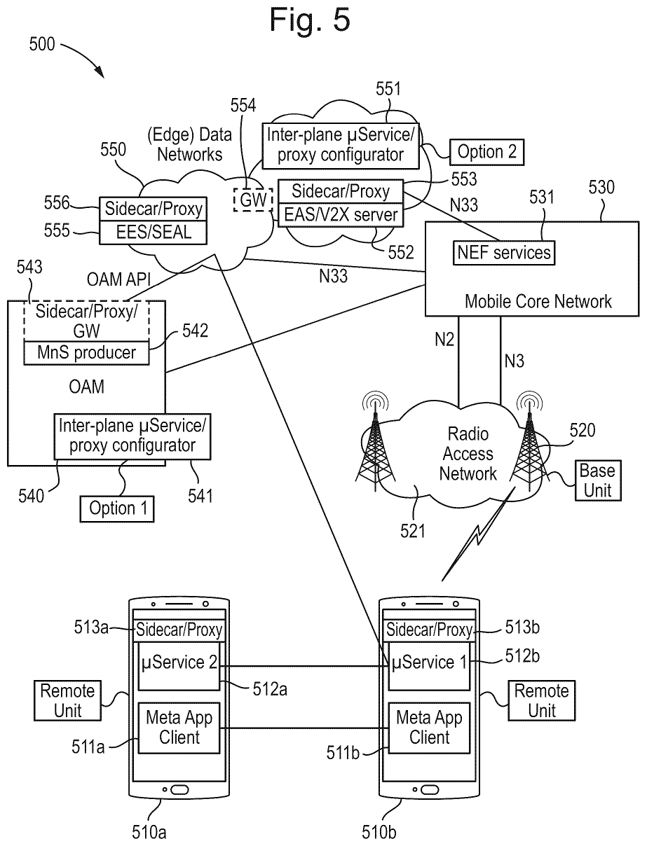

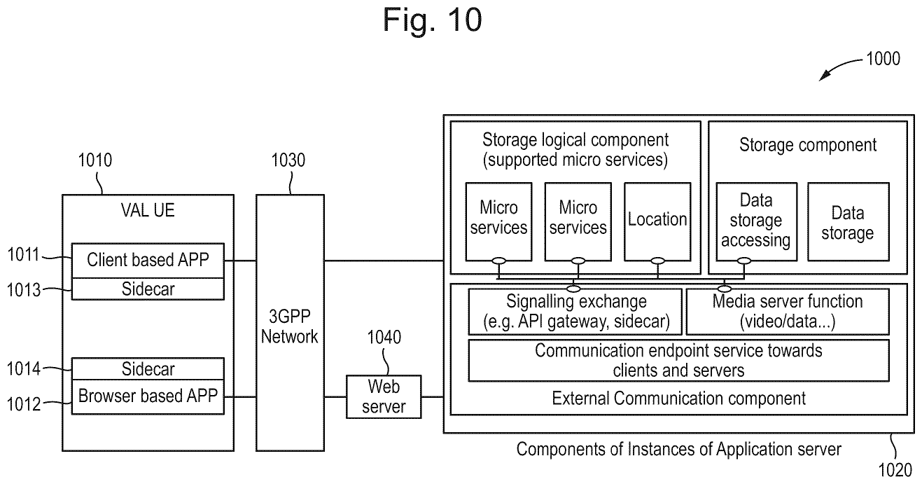

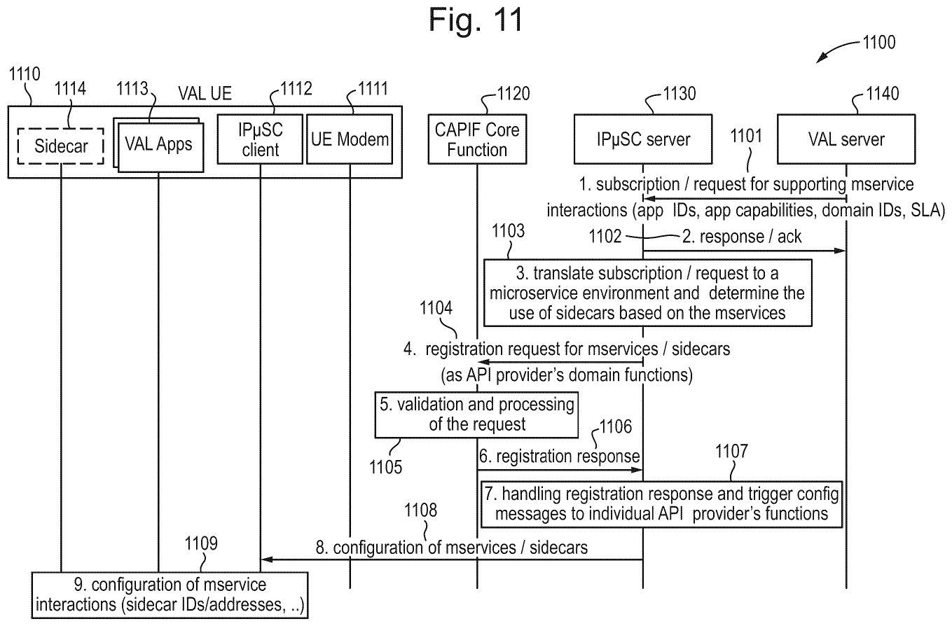

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 is in accordance with the user equipment 102 of FIG. 1, 510a and 510b of FIG. 5, 1010 of FIG. 10, 1110 of FIG. 11, for instance, and as such the reference numeral 200 is used hereinafter to indicate a user equipment apparatus in accordance with these user equipments. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

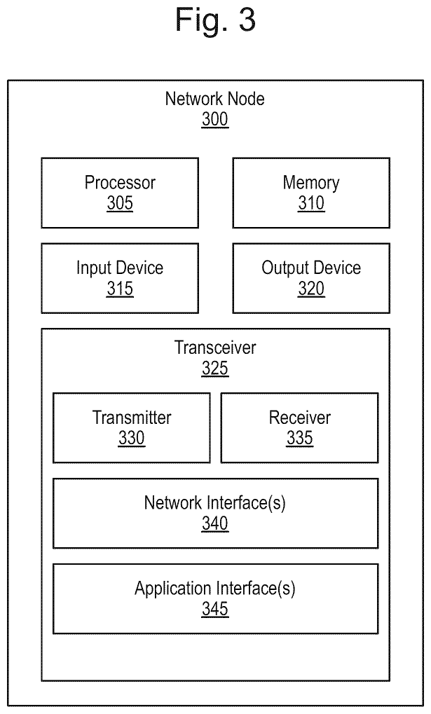

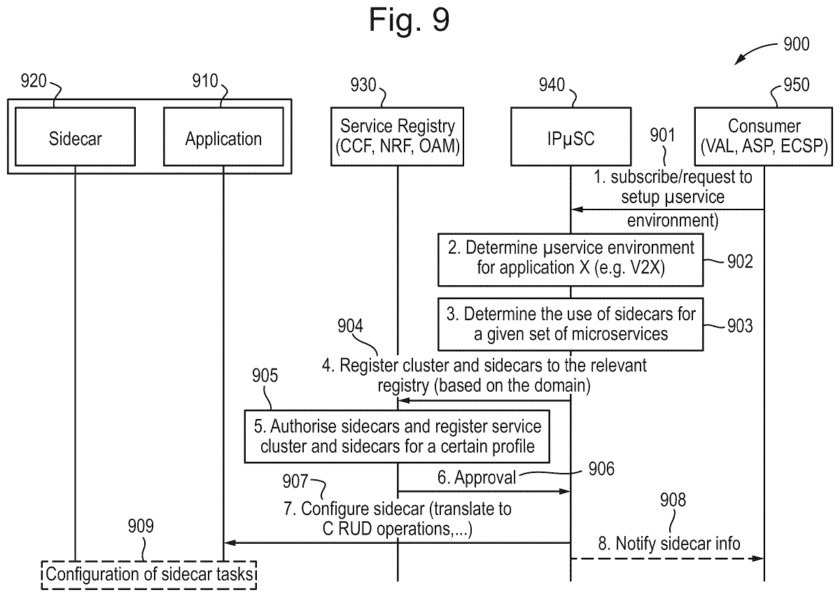

FIG. 3 depicts further details of the network node 300 that may be used for implementing the methods described herein. The network node 300 may be one implementation of an entity in the wireless communications network, e.g. in one or more of the wireless communications networks described herein. The network node 300 may be, for example, the UE 200 described above, or a Network Function (NF) or Application Function (AF), or configuration entity, or microservice provider entity, or another entity, of one or more of the wireless communications networks of embodiments described herein. For instance the network node 300 may be 540, 541, 550, or 551 of FIG. 5, it may be 940 of FIG. 9, it may be 1020 of FIG. 10 and it may be 1130 of FIG. 11. It may also be 1112 in the UE of FIG. 11. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

The disclosure herein provides a configuration entity in a wireless communication network, comprising: a transceiver arranged to receive a request for inter-plane service-based architecture management from a consumer; and a processor arranged to generate a configuration for a microservice environment based on the request, wherein the microservice environment comprises a plurality of microservices and a topology of the service based architecture; wherein the processor is further arranged to control at least one capability and/or permission related to the microservices within the microservice environment based on the configuration.

In some embodiments, the processor is further arranged to authorize the request.

In some embodiments the processor is further arranged to control the transceiver to transmit an authorization response to the consumer.

In some embodiments the processor is further arranged to generate the configuration based on a requirement for communications services across one or more communications platforms. A communications platform may be one or more of: a telco edge platform, a telco cloud platform, a virtualized core network domain, a network management domain or OAM, a MEC system, a RAN Intelligent Controller (RIC) platform, an application enablement service platform or a combination thereof.

In some embodiments the processor is further arranged to determine a sidecar, a proxy, a gateway, or any combination thereof, for one or more microservices in the plurality of microservices based on the configuration. If proxy pattern is used (similar to gateway), all the requests are transferred transparently to a service that invokes a different microservice. Here, the actual consumer is not aware of the service that is being called internally. A gateway can be defined as a service gateway such as AEF, NEF, EGMF, where in certain implementations the gateway is equivalent to an API gateway. In some embodiments the processor is further arranged to register the microservices at respective registries.

In some embodiments the respective registries comprise registries selected from the list consisting of: a Network Repository Function, NRF; a CAPIF Core Function, CCF; and an Operations Administration and Maintenance Function, OAM, service registry.

In some embodiments the processor is arranged to control the transceiver to transmit a registration request to the respective registries. Microservice parameters may include configuration data that tells it how to connect to external/3rd party services. For example, the database network location and credentials. Also, other parameters can be included for data caching (e.g. cache size and limit). Also, frameworks that aid microservices development, such as Apache Thrift and gRPC may be additional parameters.

In some embodiments the registration request comprises: an indication of microservice parameters; a microservice type; a sidecar flag; an API gateway flag and/or information; a proxy identity; a sidecar information; and a security information. The types of microservices can be in certain interpretations stateless or stateful. Stateless microservices do not maintain any state within the services across calls. They take in a request, process it, and send a response back without persisting any state information. A stateful microservice persists state in some form in order for it to function.

Furthermore, the microservice types can data centric/driven microservices (rely on their own database) or aggregator microservices. Aggregator microservice is a service that receives a request, then makes requests of multiple services, combines the results and responds to the initiating request. Examples of such microservices can be for monitoring performance data from multiple applications and provide an aggregated output after processing.

Sidecar information may include the capabilities and the identity/address of the sidecar, as well as sidecar description information and permissions required.

In some embodiments the processor is further arranged to control the transceiver to transmit the configuration for a registered microservice to a microservice provider. A microservice provider can be a vertical, a network operator, an application provider (e.g. gaming app server), an API or SDK provider, for instance. When it is mentioned that the provider receives the configuration, it is implied that the configuration is received by any authorized entity within the provider's domain and/or platform.

In some embodiments the microservice provider is a microservice provider selected from the list of microservice providers consisting of: a Vertical Application; an Application Service Provider, ASP; an API or SDK provider; a Cloud Service Provider; and a Mobile Network Operator, MNO.

In some embodiments the processor is further arranged to control the transceiver to transmit a notification to the consumer comprising information of the registered microservices so as to allow the consumer to directly interact with and/or invoke an application programming interface, API, towards the registered microservices.

In some embodiments the configuration comprises at least one of: a trigger/mapping to Create Read Update and Delete, CRUD, operations; an API configuration; a side car flag; an API gateway flag and/or information; a microservice type; a microservice permission; an exposure capability; a proxy identity; a side car information; and a security information. An exposure capability can be defined as the capability of the microservice to expose data to another platform/domain. Such capability is based on the permissions from the microservice provider and based on the service agreement among the microservice providers within the microservice environment.

In some embodiments the topology is a mesh topology.

In some embodiments, each microservice in the plurality of microservices comprises either a vertical application, a network application, a user application, or any combination thereof.

The disclosure herein further provides a microservice provider entity in a wireless communication network, comprising a transceiver arranged to receive a configuration for a microservice of a microservice environment, the microservice being registered with a respective registry, wherein the microservice environment comprises a plurality of microservices and a topology of the service based architecture; and a processor arranged to configure a microservice based on the configuration.

In some embodiments the processor is further arranged to configure a sidecar based on the configuration.

In some embodiments, each microservice in the plurality of microservices comprises either a vertical application, a network application, a user application, or any combination thereof.

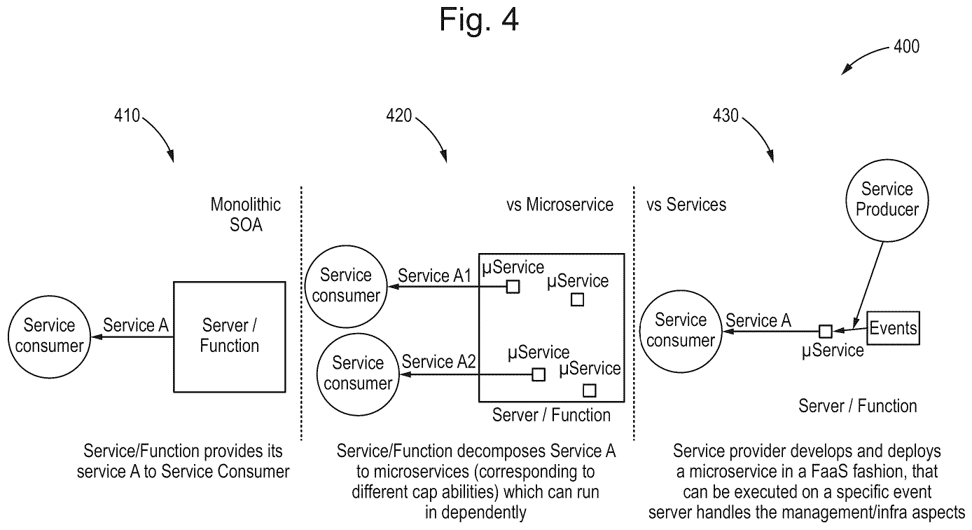

The solutions described herein relate to provision of services as microservices. Service orientated architectures have evolved towards microservices as illustrated in FIG. 4. The figure shows the evolution 400 from monolithic 410 to microservices 420 and onwards to serverless 430 architectures.

In monolithic architectures 410 a server/function provides its service (for instance Service A) to a service consumer.

In microservices 420 a server/function decomposes its service (again, Service A) into microservices (for instance Service A1 and A2) which correspond to different capabilities that can run independently. These microservices can be provided independently to service consumers.

In serverless architectures 430, a service producer develops and deploys a microservice in a function as a service fashion (FaaS), that can be executed on a specific event server that handles aspects such as management.

In the context of telecommunications, a telco service can be defined as a control plane or management plane or application plane service, or a combination thereof, which is exposable to the 3rd party customer. Such service can be for example a location service, a monitoring service, a QoS/traffic influence service, a slice LCM change, an analytics service.

Hence a microservice can be defined as a constituent of a telco service corresponding to a functional service within the communications system. Such microservice granularity depends on the MNO/telco service provider and examples of such services are: vertical applications (gaming application e.g. login server, chat server, XR applications, v2x applications); UE app services (enabler client services, AI/ML user side services etc); MnS (e.g., for PM, provisioning, MDA, . . . ) as defined in SA5; NetApps or EEL/SEAL services as defined in SA6; MEC/Edge APPs; 5GS NF/NEF services as defined in SA2 and RAN.

An example of a microservice cluster for a vertical service can be the multiplayer gaming scenario, which requires the gaming app services maybe in different edge/clouds (e.g. login server, chat server, . . . ) as well as the user applications, as well as the network services (QoS monitoring and control, network analytics services) and OAM services (slice related if the gaming service is mapped to certain slice). All these microservices can form a cluster for the given gaming scenario, and we want to enable the service-based interactions using a service mesh. In this service mesh there can be two options, one with API gateways among different domains, and one with the use of sidecars, or a combination of sidecars and GWs.

At a high architectural level the proposed system comprises one or more telco services spanning in one or more communication system domains (5GC, RAN, SEAL/EEL, platform, UE); plurality of microservices corresponding to the one or more telco services; the possible addition of proxies/sidecars for some microservices. FIG. 5 illustrates an embodiment 500 of such a high-level inter-plane microservice architecture.

The embodiment 500 illustrates remote units 510a and 510b each comprising respective meta app clients 511a and 511b, respective microservices 512a and 512b, and respective sidecars/proxies 513a and 513b. Also illustrated is a radio access network 520 comprising a plurality of base units 521. A mobile core network 530 is shown comprising NEF services 531. An OAM 540 is shown comprising an inter-plane microservice proxy configurator 541 and an MnS producer 542 with sidecar/proxy/gateway 543. An edge data network 550 is also illustrated comprising an inter-plane microservice proxy configurator 551, an EAS/V2X server 552 with sidecar/proxy 553, a gateway 554, and an EES/SEAL 555 with sidecar/proxy 556. The inter-plane microservice proxy configurators 541 and 551 (also referred to herein as IPμSC and interchangeably configuration entities or microservice configuration entities) are alternative options.

A service consumer (e.g., 3rd party, vertical customer, MNO) requests from IPμSC 541 or 551 to create a microservice environment for a specific task that can be broken down into a specific set of telco service. Service consumer provides also the subscription info/app profile.

IPμSC 541 or 551 establishes a logical microservice domain based on sidecars, according to an SLA/exposable telco service type/telco service. Such domain can be a cluster corresponding to the telco service and their individual domain information.

The IPμSC 541 or 551 configures a service mesh topology and signaling means (sidecars, gateways) to be implemented with applications (per cluster or per individual microservice). As one embodiment, a new SEAL service configures the microservice cluster and configures the use of proxies, and the capabilities per proxy and per application type. For example, Location SEAL service+LCS 5GC service+Location from 3rd party services are grouped as one service cluster. In this cluster VAL server, SEAL LMS and NEF all need to deploy a proxy since they are in different domains. Proxy will do the logs tracking and discovery of data sources. There can be different signaling means, where microservice cluster is without sidecars 513a, 513b, 543, 553, 556, or partially with sidecars 513a, 513b, 543, 553, 556, or with combination of sidecars 513a, 513b, 543, 553, 556 and gateways 554.

IPμSC 541 or 551, authorize sidecar configurations (e.g., for the OAM 540 that would involve the CRUD operations) and expose information related to the inter-plane domain and the constituent microservices/sidecars 513a, 513b, 543, 553, 556 to the involved entities. In some implementations, the IPμSC 541 or 551 provides the ID/address of the registry (keeping sidecar/microservice info) to the service consumer, also including the sidecar container information.

IPμSC 541 or 551 store sidecar information—notify, authorize sidecars 513a, 513b, 543, 553, 556/add sidecars 513a, 513b, 543, 553, 556 to a registry (e.g., CCF, NRF, OAM 540).

Service consumer discovers the sidecars 513a, 513b, 543, 553, 556 and uses the sidecar container to get monitoring events etc. The sidecar 513a, 513b, 543, 553, 556 acts transparently to the service consumer and performs logging etc. When a service consumer needs to invoke an API, the sidecar ID/address/token is used, and IPμSC 541 or 551 performs the translation to the underlying microservice interaction or sidecar-to-sidecar interaction.

In the discovery process the role of the sidecar 513a, 513b, 543, 553, 556 would be to provide the translation of the capabilities needed in order to issue a request towards a repository (i.e., NRF or MnS Discovery Service Producer 542 or CCF).

The IPμSC can be an OAM entity 541 or an entity 551 at the edge/cloud side. The sidecar capabilities can include enablement capabilities (can be NetApps, SEAL, CAPIF entities). So, the enablement entities can comprise microservices, but can also be deployed as sidecars.

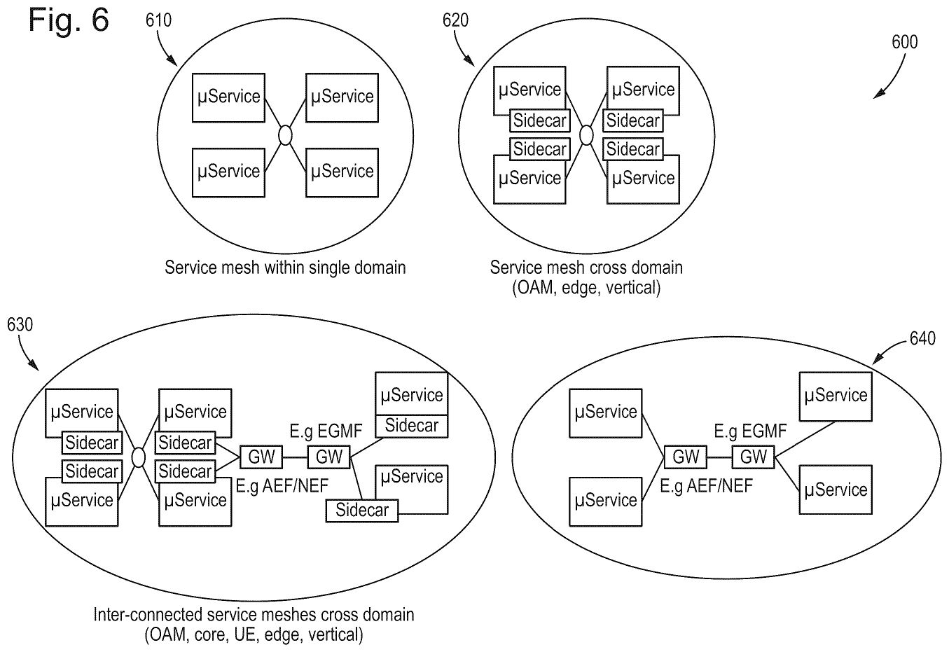

Different types of signaling 600 are illustrated in FIG. 6, where a microservice cluster is without sidecars, partially with sidecars, or a combination of sidecars and gateways. The figure shows a service mesh 610 within a single domain without sidecars. The figure also shows a service mesh 620 cross domain (OAM, edge, vertical) comprising sidecars. The figure also shows an inter-connected service meshes 630 cross domain (OAM, core, UE, edge, vertical) with sidecars and gateways. The figure also shows a service mesh 640 with gateways and no sidecars.

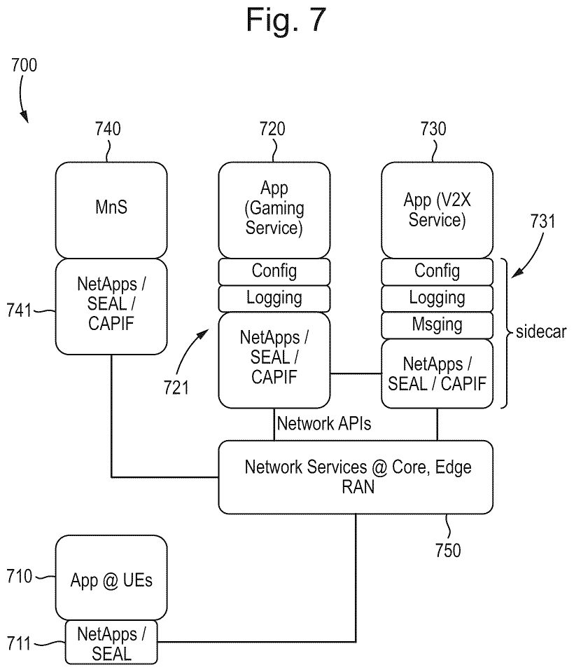

A further example of sidecar deployment is illustrated in the embodiment 700 in FIG. 7. The figure shows sidecars as enablement entities. In this figure, the App services 710, 720, 730 (at UE and network side) as well as the OAM services 740 are using sidecars 711, 721, 731, 741, such sidecars 711, 721, 731, 741 can include config/logging/messaging capabilities as well as NetApps/SEAL/CAPIF capabilities. The interaction of sidecars 711, 721, 731, 741 (on behalf of the application) with 5GC 750 can be via Network APIs (e.g., NEF APIs).

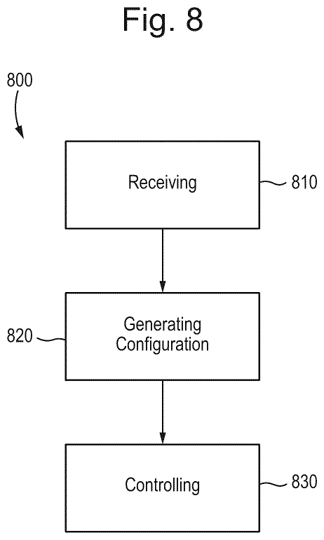

With reference to FIG. 8, a method 800 in a configuration entity in a wireless communication network can now be described.

A first step 810 comprises receiving a request for inter-plane service-based architecture management from a consumer.

A second step 820 comprises generating a configuration for a microservice environment based on the request, wherein the microservice environment comprises a plurality of microservices and a topology of the service based architecture.

A third step 830 comprises controlling at least one capability and/or permission related to the microservices within the microservice environment based on the configuration.

Some embodiments further comprising authorizing the request.

In some embodiments the authorizing the request comprises transmitting an authorization response to the consumer.

In some embodiments the configuration is generated based on a requirement for communications services across one or more communications platforms.

Some embodiments further comprise determining, a sidecar, a proxy, a gateway, or any combination thereof, for one or more microservices in the plurality of microservices based on the configuration.

Some embodiments further comprise registering the microservices at respective registries.

In some embodiments the registries comprise registries selected from the list of registries consisting of: a Network Repository Function, NRF; a CAPIF Core Function, CCF; and an Operations Administration and Maintenance Function, OAM, service registry.

Some embodiments further comprise transmitting a registration request to the respective registries.

In some embodiments the registration request comprises: an indication of microservice parameters; a microservice type; a sidecar flag; an API gateway flag and/or information; a proxy identity; a sidecar information; and a security information.

Some embodiments further comprise transmitting the configuration for a registered microservice to a microservice provider.

In some embodiments the microservice provider is a microservice provider selected from the list of microservice providers consisting of: a Vertical Application;
an Application Service Provider, ASP; an API or SDK provider; an Edge Computing Service Provider; a Cloud Service Provider; and a Mobile Network Operator, MNO.

Some embodiments further comprise transmitting a notification to the consumer comprising information of the registered microservices so as to allow the consumer to directly interact with and/or invoke an API towards the registered microservices.

In some embodiments the configuration comprises at least one of: a trigger/mapping to Create Read Update and Delete, CRUD, operations; an API configuration; a side car flag; an API gateway flag and/or information; a microservice type; a microservice permission; an exposure capability; a proxy identity; a side car information; and a security information.

In some embodiments the topology is a mesh topology.

In some embodiments, each microservice in the plurality of microservices comprises either a vertical application, a network application, a user application, or any combination thereof.

An alternative method relates to a method in a microservice provider entity, the microservice provider entity in a wireless communication network, comprising receiving a configuration for a microservice of a microservice environment, the microservice being registered with a respective registry, wherein the microservice environment comprises a plurality microservices and a topology for service based interactions; and configuring a microservice based on the configuration. In some embodiments the method further comprises configuring a sidecar based on the configuration.

FIG. 9 illustrates a further embodiment 900 of a method in a configuration entity. This embodiment describes the configuration and setup of the microservice environment and in particular the dimensioning of sidecars (and/or gateways) and the capabilities included per sidecar. Such configuration may also include the translation of the application requirements to CRUD operations (create, read, update, and delete) at the sidecar/proxy, e.g., for a sidecar on an OAM Service how to map the service requirements to standard HTTP method requests.

The embodiment 900 illustrates an application 910 with sidecar 920, a service registry 930 (such as CCF, NRF, OAM), an inter-plane microservice configuration entity IPμSC 940 and a consumer 950 (such as VAL, ASP, ECSP).

In a first step 901, the consumer 950 (who can be the 3rd party customer or the edge/cloud provider) subscribes or requests from the IPμSC 940 to setup a microservice environment for a particular use case (per application profile/service type, slice, event e.g., stadium event, . . . ).

In a second step 902, after authorizing the subscription/request (IPμSC 940 may provide a response/ack to the consumer 950), IPμSC 940 configures the microservice environment for the particular use case (e.g., for service profile X). Such configuration takes as input the SLA etc., and the requirements for telco services in different domains, and determines to migrate the required microservice to the microservice environment. Also, the configuration of APIs can be part of this configuration.

In a third step 903, based on the configuration, the IPμSC 940 determines the sidecars and/or proxies and/or gateways required for the customized setup. Sidecars/GWs can be deployed for the interactions among different domains.

In a fourth step 904, IPμSC 940 registers the microservices and the sidecars/GWs/proxies at the respective registry 930 (CCF, NRF, OAM). There can be registration to more than one registry 930, e.g for 5GC to NRF, for enablement/NEF services to CCF, for OAM services to MnS discovery service. Such registration will indicate the service parameters (API info), the service type/profile as well as whether sidecar is used. if sidecar is used, the registration includes the sidecar ID/address and info/capabilities.

In a fifth step 905, the respective service registry 930 approves/authorizes the requests and stores the registrations. Such approval can be provided by OAM/service operator's domain.

In a sixth step 906, the respective service registry 930 sends a response/ack to IPμSC 940.

In a seventh step 907, IPμSC 940 sends the configuration parameters to the respective applications 910, and in particular the configuration of triggers and mapping to CRUD operations. This step may also provide information of the sidecar 920 (identity, capabilities etc)

In an eighth step 908, IPμSC 940 notifies optionally the consumer 950 about the sidecar/GW/proxy information so as to allow the consumer 950 to directly interact/invoke API towards the sidecar 920 (otherwise this can be done via requesting the service registry 930).

In a ninth step 909, the application 910 may interact with the sidecar 920/GW for activating/initiating it and when it is needed for the operation phase the sidecar 920 translates the capabilities of the application to issue request towards MnS discovery Service producer or CCF or NRF 930.

FIG. 10 illustrates a further embodiment of a microservice deployment 1000. This embodiment provides an implementation for microservices deployed at both the device 1010 and the network 1020 sides with the support of enablement layer.

In this deployment, the VAL UE 1010 may include both client-based apps 1011 and browser based apps 1012, which can be deployed as microservices. Respective sidecars 1013 and 1014 are also provided. Application Server (VAL server) 1020 provides services to either Application Client 1011 over the 3GPP network 1030 or Web server 1040 by the manner of remote API(s). Remote API(s) invocation is carried out by http signaling over TCP/IP. Application Server 1020 provides contents (data type could be data/video) to Application Clients 1011 or Web server 1040 via media server function.

There can be two ways of signaling exchange between microservices, one is using API gateways, and the other is via sidecars. More domains can also be interacting (SEAL layer, VAL layer, OAM, MEC system) via sidecars.

In such a deployment, the role of enabler layer can be: configuring the microservice environment consisting of device services and application services; configuring the use of sidecars based on the needed microservices; registering the microservices/sidecars to CAPIF Core Function; sending the configuration parameters related to the sidecar operation; and instantiating sidecars at the VAL UEs via enablement layer.

FIG. 11 illustrates a further embodiment of a method 1100 using a configuration entity and microservice provider entity. The embodiment 1100 shows a VAL UE 1110 comprising a UE modem 1111, an IPμSC client 1112, VAL Apps 1113 and a sidecar 1114. Also shown is a CAPIF core function 1120, an IPμSC server 1130 and a VAL server 1140.

In a first step 1101, the VAL server 1140 subscribes or requests from the IPμSC server 1130 to setup a microservice environment for a particular use case (per application profile/service type, slice, event e.g., stadium event, . . . ).

In a second step 1102, after authorizing the subscription/request, the IPμSC server 1130 provides a response/ack to the VAL server 1140.

In a third step 1103, IPμSC server 1130 configures the microservice environment for the particular use case (e.g., for service profile X). Such configuration takes as input the SLA etc., and the requirements for telco services in different domains (incl the device side), and determines to migrate the required microservice to the microservice environment. Also, the configuration of APIs can be part of this configuration. Based on the configuration, the IPμSC server 1130 determines the sidecars and/or proxies required for the customized setup. Sidecars can be deployed for the interactions among different domains.

In a fourth step 1104, IPμSC server 1130 registers the microservices and the sidecars at the CCF 1120, using a registration request message (acting as API provider for the corresponding APIs). The registration request may include the parameters provided in Table 1 below.

TABLE 1

| Information | | |
|---|---|---|
| element | Status | Description |
| List of API provider | M | List of API provider domain |
| domain applications/ | | applications/microservices |
| microservices | | |
| Microservice | M | The description of microservice |
| environment | | environment and the domain it belongs as |
| descriptor | | well as the type (e.g. OAM service, SEAL |
| | | service, . . .) |
| Sidecar flag | M | Whether sidecar will be used or not |
| Sidecar information | O | If used, the sidecar ID, API info, |
| (ID, address) | | capabilities (logging, msging, confg) and |
| | | the mapping to application/microservice. |
| Security information | M | Information for CAPIF core function to |
| | | validate the registration request |

In a fifth step 1105, CCF 1120 validates the received request and generates the identity and other security related information for all the API provider domain applications listed in the registration request.

In a sixth step 1106, CCF 1120 send to the IPμSC server 1130 a registration response.

In a seventh step 1107, IPμSC server 1130 configures the received information to the individual API provider domain applications/microservices and triggers messages towards them.

In an eight step, IPμSC server 1130 sends to the IPμSC client 1112 of the VAL UE 1110 of interest the configuration of the microservices/sidecars along with information for interacting within the microservice environment (IDs/addresses/API info/transport protocols, . . . ).

In a ninth step, IPμSC client 1112 helps instantiating the sidecar 1114 at the VAL UE 1110 and configures the sidecar 1114 with the requested capabilities.

In 3GPP there can be different interactions among different planes/domains (OAM, 5GS, application enablement), since the enablement layer is on top of the 5G core and OAM, and there are interactions via APIs which can be service based. Such interactions may involve different MNOs, ECSPs, CSPs, verticals, ASPs/enterprises. To have inter-plane SBA for some cases including multiple service providers, then there needs to be a secure, flexible, and consumer-friendly architecture.

The problem is how to enable inter-domain SBA communication, and one particular implementation is assuming that vertical apps and network apps run as microservices. In this case, the use of service mesh shall be an implementation choice. Assuming that scenario, the more specific problem is how to configure the microservices environment for a particular use case (e.g. application service profile like V2X) and use sidecars/gateways (GWs) for the inter-plane interactions (e.g. OAM-vertical plane, 5GC-vertical plane, ECSP-vertical plane). In certain cases, the NetApps can be bundled within a sidecar and can be deployed together with the vertical apps in a customized manner on demand.

This solution translates an application service requirement to the use of microservice based interactions and configures the microservice environment as well as the use of sidecars/gateways. Subsequently, the mechanism configures the capabilities of the needed sidecars and registers them to a service registry. Finally the configurations are sent to the microservice providers, and the service mesh is created and ready to operate.

Closest solutions are different due to the fact that the microservice based architecture and the dimensioning/configuration of sidecars is not discussed; or provide mechanisms for configuring the resources for microservices for edge services only. The disclosure herein in contrast provides the configuration of the capabilities and not the resources and also targets inter-plane SBA including also the apps of the UEs.

More specifically the exemplar embodiments describe the configuration and setup of the microservice environment and in particular the dimensioning of sidecars/gateways and the capabilities included per sidecar; and provide an implementation for microservices deployed at both the device and the network side with the support of enablement layer.

The following clauses also embody aspects of the disclosure herein.
1. A method for supporting inter-plane microservice based interactions in a wireless communication system, the method comprising: obtaining a requirement for inter-plane SBA management from an external consumer (vertical, ASP, service provider); configuring a microservice environment based on the requirement, wherein the microservice environment comprises a plurality of vertical applications, a network applications, user applications, and a topology for the service-based interactions; controlling microservice capabilities and permissions the (of the sidecar and/or gateway, wherein the capability can be the sidecar or gateway logic constituent, e.g., logs, monitoring, storage).
2. The method of claim 1, further comprising translating the requirement to a microservices instantiation requirement.
3. The method of claim 1, further comprising determining the need of a sidecar and/or gateway and/or proxy per configured microservice within the set of network and/or user applications.
4. The method of claim 1, further comprising registering the configured microservice (and the mapped sidecar/gateway) within the set of network and/or user applications to service discovery registry.
5. The method of claim 4, further comprising sending the configuration for the registered microservice to the microservice provider (e.g. vertical, ASP, MNO)
6. The method of any preceding claim wherein the requirement comprises the parameters . . .
7. The method of any preceding claim wherein the inter-plane SBA topology is a mesh topology.
8. The method of any preceding claim wherein the microservice capabilities comprise . . .
9. The method of any preceding claim wherein registering comprises a request/response and includes the following parameters . . . .

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document:
3GPP 3rd Generation Partnership Project
SOA Service Oriented Architecture
AWS Amazon Web Services
SEAL Service Enabler Architecture Layer
ASP/SP Application Service Provider/Service Provider
MnS Management Service
SBMA Service Based Management Architecture
ECSP Edge Computing Service Provider
CSP Cloud Service Provider
NSCE Network Slice Capability Enablement
ADAES Application Data Analytics Enablement
CCF CAPIF Core Function
AEF API Exposure Function
LCM Life Cycle Management
MDA Management Domain Analytics
EEL Edge Enabler Layer
IPμSC Inter-Plane μService Configurator
LCS Location Services
CRUD Create, read, update and delete
CAPIF Common API Framework
GW Gateway
VAL Vertical Application Layer

1. A method performed by a configuration entity, the method comprising:
receiving a request for inter-plane service-based architecture management from a consumer;
generating a configuration for a microservice environment based on the request, wherein the microservice environment comprises a plurality of microservices and a topology of the service based architecture; and
controlling at least one capability or permission related to the microservices within the microservice environment based on the configuration.

2.-15. (canceled)

16. A configuration entity in a wireless communication network, comprising:
at least one memory; and
at least one processor coupled with the at least one memry and configured to cause the configuration entity to:
receive a request for inter-plane service-based architecture management from a consumer;
generate a configuration for a microservice environment based on the request, wherein the microservice environment comprises a plurality of microservices and a topology of the service based architecture; and
control at least one capability or permission related to the microservices within the microservice environment based on the configuration.

17. The configuration entity according to claim 16, wherein the at least one processor is further configured to cause the configuration entity to authorize the request.

18. The configuration entity according to claim 17, wherein the at least one processor is further configured to cause the configuration entity to transmit an authorization response to the consumer.

19. The configuration entity of claim 16, wherein the at least one processor is further configured to cause the configuration entity to generate the configuration based on a requirement for communications services across one or more communications platforms.

20. The configuration entity of claim 16, wherein the at least one processor is further configured to cause the configuration entity to determine a sidecar, a proxy, a gateway, or any combination thereof, for one or more microservices in the plurality of microservices based on the configuration.

21. The configuration entity of claim 16, wherein the at least one processor is further configured to cause the configuration entity to register the microservices at respective registries.

22. The configuration entity of claim 21, wherein the respective registries comprise registries selected from:
a Network Repository Function (NRF);
a CAPIF Core Function (CCF); or
a Operations Administration and Maintenance Function (OAM) service registry.

23. The configuration entity of claim 21, wherein the at least one processor configured to cause the configuration entity transmit a registration request to the respective registries.

24. The configuration entity of claim 23, wherein the registration request comprises:
an indication of microservice parameters;
a microservice type;
a sidecar flag;
an API gateway flag or information;
a proxy identity;
a sidecar information; and
a security information.

25. The configuration entity of claim 21, wherein the at least one processor is further configured to cause the configuration entity to transmit the configuration for a registered microservice to a microservice provider.

26. The configuration entity of claim 25, wherein the microservice provider is a microservice provider, including:
a Vertical Application;
an Application Service Provider (ASP);
an API or SDK provider;
a Cloud Service provider; or
a Mobile Network Operator (MNO).

27. The configuration entity of claim 21, wherein the at least one processor is further configured to cause the configuration entity to transmit a notification to the consumer comprising information of the registered microservices so as to allow the consumer to directly interact with or invoke an application programming interface (API) towards the registered microservices.

28. The configuration entity of claim 16, wherein the configuration comprises at least one of:
a trigger/mapping to Create Read Update and Delete (CRUD) operations;
an API configuration;
a side car flag;
an API gateway flag or information;
a microservice type;
a microservice permission;
an exposure capability;
a proxy identity;
a side car information; or
a security information.

29. The configuration entity of claim 16, wherein the topology is a mesh topology.

30. The configuration entity of claim 16, wherein each microservice in the plurality of microservices comprises either a vertical application, network application, user application, or any combination thereof.

31. A microservice provider entity in a wireless communication network, comprising
at least one memory; and
at least one processor coupled with the at least one memory and configured to cause the microservice provider entity to:
receive a configuration for a microservice of a microservice environment, the microservice being registered with a respective registry, wherein the microservice environment comprises a plurality of microservices and a topology of the service-based architecture; and
configure a microservice based on the configuration.

32. The microservice provider entity of claim 31, wherein the at least one processor is further configured to cause the microservice provider entity to configure a sidecar based on the configuration.

33. The microservice provider entity of claim 31, wherein each microservice in the plurality of microservices comprises either a vertical application, network application, user application, or any combination thereof.

34. A method performed by a microservice provider entity, the method comprising receiving a configuration for a microservice of a microservice environment, the microservice being
registered with a respective registry,
wherein the microservice environment comprises a plurality of microservices and a topology of the service-based architecture; and
configure a microservice based on the configuration.
